(19) United States
(12) Patent Application Publication
(10) Pub. No.: US 2025/0382555 A1
(43) Pub. Date: Dec. 18, 2025

(54) Integrated Process for Extracting, Separating, Distilling, and Producing Water-Soluble Hop Compounds for Brewing

(71) Applicants: Eric Jay Duchin, Napa, CA (US); Jacob John Enslein, Laguna Beach, CA (US); Alexander David Hinshaw, Santa Monica, CA (US); Mark Vuozzo, San Diego, CA (US); Dean McKay, Saint Paul, OR (US)

(72) Inventors: Eric Jay Duchin, Napa, CA (US); Jacob John Enslein, Laguna Beach, CA (US); Alexander David Hinshaw, Santa Monica, CA (US); Mark Vuozzo, San Diego, CA (US); Dean McKay, Saint Paul, OR (US)

(21) Appl. No.: 19/238,159

(22) Filed: Jun. 13, 2025

Related U.S. Application Data
(60) Provisional application No. 63/659,717, filed on Jun. 13, 2024.

(51) Int. Cl. C12C 3/12; C12C 3/08; C12C 5/02

(52) U.S. Cl. CPC C12C 3/12; C12C 3/08; C12C 5/026

(57) ABSTRACT

The present invention discloses an integrated process for hop extraction, separation, distillation, and water-soluble production. The process enhances brewing efficiency and preserves volatile compounds, resulting in high-quality hop extracts. The process improves upon existing techniques in the prior art by allowing for greater preservation of volatile aromatic and flavor compounds from the processed hops.

### FIELD OF THE INVENTION

The present invention relates generally to the field of hop extraction and brewing. More specifically, hop extraction and brewing involving the use of non-polar solvents, separation processes, distillation techniques, and water-soluble product production.

### BACKGROUND OF THE INVENTION

Traditional hop extraction and brewing processes face challenges in achieving efficient separation of bitter and flavor compounds while preserving volatile terpenes. The present invention seeks to overcome these challenges by integrating a novel extraction, separation, distillation, and water-soluble production process.

In the realm of brewing, the utilization of common hop extracts poses multifaceted challenges. Brewers contend with the loss of hop complexity and diversity in flavor and aroma, heightened susceptibility to oxidation affecting freshness, and the intricacy of achieving consistent flavor profiles due to variability in extraction processes. Additionally, there is a struggle to preserve the unique characteristics of hop varieties and manage concerns related to residual solvents impacting beer flavor. The higher concentrations of bittering compounds present in some extracts pose difficulties in achieving balanced bitterness. Cost considerations and potential consumer perception challenges further contribute to the complexity. Lastly, the limited control over individual hop compounds in the final beer underscores the necessity for an improved extraction process, as presented in this patent, to address and overcome these intricacies in hop extraction and brewing practices.

### BRIEF DESCRIPTION OF THE DRAWINGS

FIG. 1 is a flow diagram for an embodiment of the present invention.

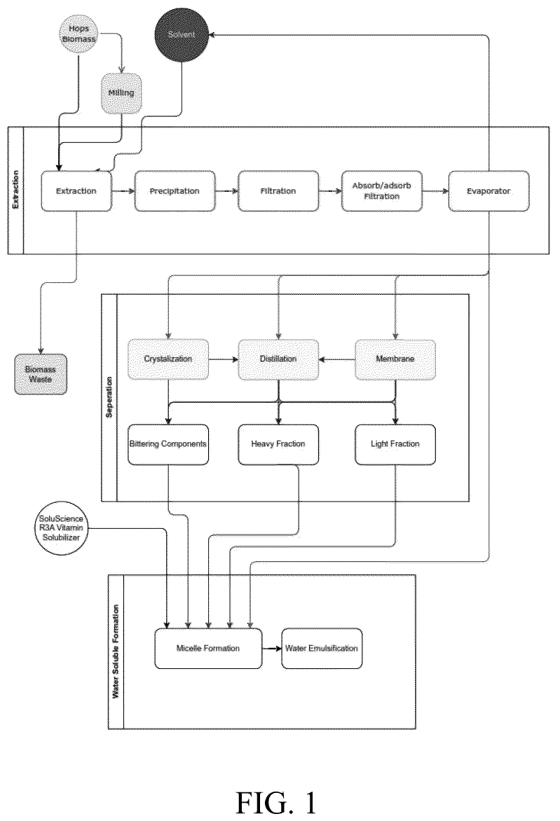

FIG. 2 is an input diagram showing the material inputs to initiate the process for an embodiment of the present invention.

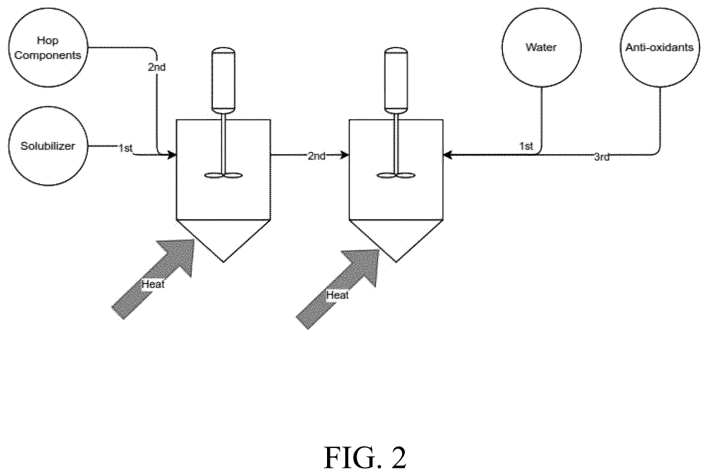

### DETAIL DESCRIPTIONS OF THE INVENTION

All illustrations of the drawings are for the purpose of describing selected versions of the present invention and are not intended to limit the scope of the present invention.

The present invention is a method comprising an integrated process that encompasses hop extraction using subcritical/non-polar solvents, separation via filtration and crystallization, distillation under controlled conditions, and water-soluble product production. This process enhances the efficiency and quality of hop extracts for brewing. The process encompassing the present invention comprises a series of steps broken down into several major categories comprising extraction, separation, refinement, isolation, and production.

### Separation Process via Crystallization and Fractionation

Steps for separating bitter compounds from flavoring compounds, comprising:
a. Crystallizing and filtering out bitter compounds from the solution, using crystallization techniques such as seeding, flash evaporation, cold crashing, or slow evaporation;
b. Separating alpha and beta compounds from each other through acid-base chemistry, water chemistry, salting out, pH adjustment, liquid-liquid extraction, filtration, crystallization, evaporation, or crashing.

### Fractional Short Path Distillation for Separation of Bittering and Flavor Compounds

Steps for distilling hop compounds, comprising:
a. Separating bittering and flavor compounds distillation with controlled maximum heat;
b. Progressing through multiple temperature points to optimize pressure and heat, yielding specific fractions for selective inclusion in products.
c. Adjusting vacuum levels and temperature variations during distillation for customized separation of terpene-rich compounds, alpha/beta/iso product, and other fractions.

### Integrated Hop Extraction, Separation, Distillation, and Production Steps

Steps for producing hop extracts for brewing, comprising:
a. Extracting hop biomass using subcritical and/or near-critical non-polar solvents with dielectric constants between 1-30 in an oxygen-free atmosphere, allowing liquid solvent to flow over and through the biomass, or be used to soak the biomass, with optional physical agitation during extraction;
b. Filtering the extraction solution with physical filtration between 0.2-5 microns, and incorporating co-solvents for specific target compounds;
c. Adjusting the extraction solution's pH, dielectric constant, or solubility, and interacting the extraction solution with electron support or transfer media, or adsorbent media selected from carbon ash, activated carbon ash, zeolites, silicates, aluminas, plastics, etc.;
d. Separating bitter compounds from flavoring compounds through crystallization techniques, including seeding, flash evaporation, cold crashing, or slow evaporation, and further separating alpha and beta compounds through acid-base chemistry, water chemistry, salting out, pH adjustment, liquid-liquid extraction, filtration, crystallization, evaporation, or crashing;
e. Distilling the hop compounds through short path distillation with controlled maximum heat, progressing through multiple temperature points to optimize pressure and heat, adjusting vacuum levels and temperature variations during distillation for customized separation of terpene-rich compounds, alpha/beta/iso product, and other fractions;
f. Producing water-soluble hop products by emulsifying the bittering and flavor components, utilizing saponin technology, Rick's emulsifier technology, membrane technology with nanopore tubular membranes, or glycosidase activity to increase flavor potency.
   Method of Brewing with the Extracts Obtained

Steps for brewing, comprising the step of incorporating the hop extracts produced according to claim 1 into beer, soda, juice, or other beverages, ensuring optimal separation and preservation of volatile compounds, and adjusting ratios of alpha, beta, and iso compounds to achieve desired flavor profiles.

### Steps for Separating Bitter and Flavoring Compounds by Crystallization

1. Extraction
   a. Subcritical and/or near critical non polar solvents with dielectric constants between 1-30 (such as but not limited to light alkanes including butane, propane, etc. or hydroflourocarbons including 1 1 1 2-tetrafluoroethane, or flourocarbons including perflourobutane) are used to extract whole hop biomass, partial hop biomass, processed hop biomass e.g. pellets, filtered hop biomass, or any hop biomass. This extraction is performed in an oxygen-free atmosphere. Liquid solvent(s) can flow over and through biomass or be used to soak biomass or any combination. Physical agitation is also possible during extraction.
   b. The extraction solution may be filtered with physical filtration between 0.2-5 micron.
   c. The extraction solution may include co-solvents for certain target compounds.
   d. The extraction solution may be electrically charged, or it's pH, dielectric constant, or solubility adjusted.
   e. The extraction solution may interact with electron support or transfer media, or adbsorbant media. (media (including but not limited to, carbon ash, activated carbon ash, zeolites, silicates, aluminas, plastics, etc)
2. Separation
   a. The bitter compounds may be crystalized and filtered out of solution leaving flavoring compounds behind. Alpha & beta crystallization techniques include but are not limited to seeding, flash evaporating solvent, cold crashing, slowly evaporating solvent, etc. Filtering crystals is achieved by maintaining crystal formation conditions in a filter with porosity FILL IN HERE (broad range or accurate to us?). Crystallization may be performed in batch reactors or in continuous crystallization reactors.
   b. The alpha, beta, compounds may be separated from each other. In the case of this process, we may take extracted hop product that has had the flavor, aroma, and brewing relevant compounds removed and separate its individual constituents of alpha acids, beta acids, and iso acids. This separation may utilize acid-base chemistry, water chemistry, salting out, pH, liquid-liquid extraction or further filtration, crystallization, evaporation, or crashing.
   c. The xanthohumol may be isolated through various techniques to be evaluated but may include spinning cone distillation, freezing point distillation with or without chilled centrifugation, chilled centrifugation on its own or in combination with other distillation or separation techniques, chromatography-preparative, highspeed counter current, silica-based column or plate chromatography, centrifugal partition chromatography, flash evaporation, flash chromatography, condensation, evaporation or combination of any techniques with commonly known influencers such as pH, electron support structures, or others.
3. Distillation
   a. Bittering and flavor compounds may also be separated via short path distillation with maximum heat control. By limiting the max temperature in a still's boiler to X and distilling under vacuum Y and condensing vapors in flasks using (reference Siegel tech) at temperatures W,Z, and vapor distances S, R from the boiler the flavor compounds can be distilled and the bittering compounds left isolated.
   b. The process encompasses a series of distillation steps designed to refine the extracted compounds. Beginning at room temperature with a vacuum below 1000 microns, the system progresses through multiple temperature points, optimizing pressure and heat to yield specific terpene fractions. This fractionation process enables customization based on strain characteristics, resulting in diverse and potent extracts for brewing.
   c. The distillation process initiates with the carefully managed distillation of degassed or non-degassed terpene-rich hops extract at room temperature. A stir bar or equivalent method is employed to ensure a thin film of oil for optimal exposure. The vacuum is progressively increased to just below 1000 microns until the first appearance of liquid in either collection flask. This vacuum level is maintained for the initial phase and then lowered for subsequent steps.
   d. To prevent muffining and facilitate the breakdown of high-energy crystals, the vacuum is released as needed, and heat is applied accordingly. At each elevated vacuum point, all flowing liquids are collected. The micron level is then held between 300-500 while increasing the temperature from room temperature up to 40° C., collecting every flask after no perceivable flow at 40° C. The micron is subsequently reduced to 250 at 40° C., held until no flow is detected, and this cycling continues until no flow is observed at 55° C., collecting all materials.
   e. This fraction primarily consists of monoterpene-rich compounds, with higher-temperature collections gradually diminishing in purity, typically ranging from 95-99% pure hop terpenes. Adjusting the vacuum depth with temperature variations, the process advances to 70° C. for the initial cut, capturing the first sesqui and diterpene fraction. Subsequent cuts are made at 90° C., 110° C., 120° C., 130° C., and 140° C. The distillation can conclude at 140° C. for the isolation of iso/alpha/beta product, or optionally, it may continue to 170° C. for a more exhaustive strip, albeit with a risk of isomerization. In many cases, as the temperature increases, the vacuum level decreases-scaling in this fashion until the ultimate vacuum level of the pump is achieved. (less than one micron).
   f. At this point, distinct fractions are obtained, with more water-soluble components on the cold finger, lighter monoterpenes in the cold collection flask, and heavier sesqui and diterpenes in the room-temperature flask fractions. Compounds like esters, phenolics, and thiols coexist with sesqui and diterpenes, particularly in high-temperature collections starting above 70° C. The alphas, betas, and isos are concentrated in the boiling flask material.
   g. The distillation process can be executed with fewer set cuts for 1-3 hours or with numerous set cuts over 12 hours, balancing between speed and thoroughness to ac The flavor compounds can be further isolated with known methods (reference other patents) to make isolates. The flavor compounds can be left in their whole fractions as well. At least one room temperature receiving flask, cold finger, and cold flask in the distillation setup collects more volatile components, which brewers boil off separately from the flavor compounds-and brewers try to add back in with extra hop protocols, allowing the proper dosing of volatile components in final formulations.
   h. Cultivar-specific terpenes are methodically collected based on their weight. Lighter terpenes, known for their distinct aroma contributions, are gathered in the cold finger and cold collection vessel, and stored in a low-moisture, vacuum-sealed environment at low temperatures. The alpha/beta/iso product can be blended with strain-specific terpenes to achieve desired ratios, or separated using pH swing, water chemistry, filtration, and evaporation methods. This customization aspect allows brewers to tailor the extract to meet specific flavor profiles. The proposed extraction process brings several advantages to the brewing industry, including heightened efficiency, reduced costs through optimized material transfer, and an improved overall quality of the final hops extract. The method is designed to minimize damage to terpenes, ensuring a higher yield of pure, aromatic compounds for brewing and achieving maximum yield and purities.
   i. During the method of collecting boiling flask materials, homogenizing, and redistilling them for all volatiles before utilization in brewing. This meticulous approach ensures optimal separation and preservation of volatile compounds.
   j. In this process products could be stored at low temperatures, medium vacuum, and out of light. Our method produces a hop extract which due to high volatiles may be preserved through refrigeration.
   k. Other distillation methods such as spinning cone, spinning band, rolled film, wiped film, thin film, and various other distillation methodologies achieve similar results when they are properly deployed as a part of the process.
   l. All terpene-rich products are best stored at low temperatures, medium vacuum, and out of light. This practice goes for most extracts and products for brewing and the brewer receives these products cold.
   m. Other distillation methods such as spinning cone, spinning band, rolled film, wiped film, thin film, and various other distillation methodologies achieve similar results when they are properly deployed as a part of the process.
4. Isomerization
   a. The Bittering compounds can be acted on via known methods (reference all other patents) to make alpha/beta isolated, isomerized versions, etc. The bittering compounds can be left as a whole fraction with trace hop components and in the ratios given by the unique hop variety they are sourced from.
5. Water-Soluble Production
   a. Water-soluble ready-to-brew products are produced by emulsifying the bittering and flavor components.
      i. emulsifier tech
         1. Using constant agitation to prevent gelation, mix solubilizer and hop components near melting point of solubilizer.
         a. There exists a critical temperature range within which the hop components and solubilizer will mix;
         i. 40f-150f
         b. Slowly Add hop component-solubilizer mixture to water within the critical temperature range, maintaining temperatures for micelle formation.
         i. Too much agitation and a foam forms, leading to loss
         ii. Too little agitation and no emulsification forms
         iii. If one component is too cold then a non-homogenous gel forms
      ii. Membrane
         1. Membrane technology utilizing a tubular membrane with a particle size lower than the desired nanoemulsion. Two sides, nanopore and bulk support. Pump high crossflow across the membrane. Have water nonporous side, and a premix of ethanol, hops extract, and emulsifier support side. Backflow premix through membrane, the extrusion will produce droplets and the fast cross flow of water will immediately wash them into bulk solution as liposomes. With zero temperature control.
      iii. Glycosidase activity to increase flavor potency in extract, possible, and preferential due to water-soluble.
         1. In one embodiment of this process, as part of the process water soluble from the membrane process (or any process) is constituted with water and glycosidased (exposed to a glycosidase) either isolate or derived through on-site fermentation, over a period of time, several weeks to be preferred, and then evaporated using membranes, and re-water solubilized. The resulting solution will have substantially higher volatile organic compounds.

Although the invention has been explained in relation to its preferred embodiment, it is to be understood that many other possible modifications and variations can be made without departing from the spirit and scope of the invention.

1. A method for processing water-soluble hop brewing compounds the steps comprising:
providing hops;
providing a liquid solvent;
inundating the hop biomass with the liquid solvent;
allowing the liquid solvent to create an extraction solution of bitter and flavoring compounds from the hops;
filtering the extraction solution to refine the extraction solution;
crystalizing the bitter compounds in the solution;
filtering out the crystalized compounds from the solution;
isolating any remaining desired compounds;
refining the extraction solution;
isomerizing of the bitter compounds;
emulsifying the filtered bitter compounds; and
emulsifying the extraction solution flavoring compounds.
